(19) United States
(12) Patent Application Publication
(10) Pub. No.: US 2008/0175349 A1
(43) Pub. Date: Jul. 24, 2008

(54) MASKLESS EUV PROJECTION OPTICS

(75) Inventor: James P. McGuire, Pasadena, CA (US)

Correspondence Address: KNOBBE MARTENS OLSON & BEAR LLP, 2040 MAIN STREET, FOURTEENTH FLOOR, IRVINE, CA, 92614, US

(73) Assignee: Optical Research Associates, Pasadena, CA (US)

(21) Appl. No.: 12/014,699

(22) Filed: Jan. 15, 2008

Related U.S. Application Data
(60) Provisional application No. 60/880,571, filed on Jan. 16, 2007.

(51) Int. Cl. G21K 5/00

(52) U.S. Cl. 378/34; 250/492.2

(57) ABSTRACT

Various embodiments provide projection optics comprise a plurality of mirrors that provide high demagnification of, for example, about one hundred times or more. The projection optics may be used for photolithography processes, such as extreme ultraviolet lithography processes, to pattern microstructures.

### CROSS-REFERENCE TO RELATED APPLICATIONS

This application claims priority to U.S. Provisional Patent Application Ser. No. 60/880,571, filed Jan. 16, 2007, which is hereby incorporated by reference in its entirety.

### BACKGROUND OF THE INVENTION

1. Field of the Invention

Various embodiments provide projection optics comprising a plurality of mirrors that provide high demagnification of about one hundred times or more. The projection optics may be used for photolithography processes, such as extreme ultraviolet lithography processes, to pattern microstructures.

2. Description of the Related Art

Microlithography can be used in semiconductor device fabrication and for patterning of microstructures such as micromechanical systems, micro-optics, porous membranes, etc. The trend in the art of IC fabrication is to increase device density by increasing the resolution of lithography systems. One promising alternative to current photolithography technology that employs ultraviolet light of 248 or 193 nm is a lithographic technique known as extreme ultraviolet (EUV) lithography where wavelengths in the range of about 11 nm to about 14 nm are used to expose the photoresist global layer. The shortened wavelength provides increased resolution for producing smaller feature size.

Some EUV lithography techniques utilize masks. For instance, patterns can be formed on a photoresist layer by reflecting light energy off a mask (or reticle) having the pattern formed for example by a tantalum nitride absorber layer thereon. An optical imagining system is used to transfer the pattern to the photoresist material. Exposed photoresist material can become soluble such that it can be removed to selectively expose an underlying layer (e.g., a semiconductor layer, a metal or metal containing layer, a dielectric layer, etc.). Portions of the photoresist layer not exposed to a threshold amount of light energy will not be removed and serve to protect the underlying layer. The exposed portions of the underlying layer can then be etched (e.g., by using a chemical wet etch or a dry reactive ion etch (RIE)) such that the pattern formed from the photoresist layer is transferred to the underlying layer. Alternatively, the photoresist layer can be used to block dopant implantation into the protected portions of the underlying layer or to retard etching of the underlying layer. Thereafter, the remaining portions of the photoresist layer can be stripped.

However, attempts to implement EUV lithography using a mask face a number of limitations. A mask set can be expensive, with a single set exceeding more than one million dollars. These costs can make use of such masks impractical for low volume products. What is needed are EUV photolithography techniques that can overcome these limitations.

### SUMMARY OF THE INVENTION

In some embodiments, a maskless extreme ultraviolet photolithography system is provided. The system comprises a reflective relay including at least a first mirror, a second mirror, a third mirror, a fourth mirror, a fifth mirror, a sixth mirror, a seventh mirror and an eighth mirror arranged in an optical path from an object plane to an image plane for imagining a spatial light modulator in said object plane into a wafer in said image plane, said mirrors having a shape and location with respect to each other within the optical path such that said reflective relay yields a reduction ratio of at least about 100 times.

In some embodiments, a method of patterning a semiconductor wafer is provided. The method includes modulating extreme ultraviolet light to form an object pattern; reflecting said modulated extreme ultraviolet light from a first mirror, a second mirror, a third mirror, a fourth mirror, a fifth mirror, a sixth mirror, a seventh mirror and an eighth mirror to form an image pattern; and demagnifying said image pattern by at least 100 times relative to said object pattern, and exposing said semiconductor wafer with said image pattern.

In some embodiments, an EUV optical projection system is provided. The system includes an extreme ultraviolet light source; an array of spatial light modulators configured to modulate light generated from the light source to form an object pattern; and at least eight mirrors configured to image said object pattern to form an image pattern on a wafer and to reduce said image pattern by at least about 100 times relative to said object pattern.

In some embodiments, an optical imaging system is provided. The system includes a reflective relay comprising at least a first mirror, a second mirror, a third mirror, a fourth mirror, a fifth mirror, a sixth mirror, a seventh mirror and an eighth mirror arranged in an optical path from an object plane to an image plane for imaging a spatial light modulator in said object plane onto a wafer in said image plane, said mirrors having a shape and location with respect to each other within the optical path such that said reflective relay yields a reduction ratio of at least about 100 times.

### BRIEF DESCRIPTION OF THE DRAWINGS

FIG. 1 shows a schematic bock diagram of a photolithography system.

FIGS. 2A and 2B show a ray trace of an example apparatus that uses an array of modulators to form an image on a wafer.

FIGS. 3A and 3B show a ray trace of another example apparatus that uses an array of modulators to form an image on a wafer.

FIGS. 4A and 4B show a ray trace of another example apparatus that uses an array of modulators to form an image on a wafer.

FIGS. 5A and 5B show a ray trace of another example apparatus that uses an array of modulators to form an image on a wafer.

FIGS. 6A and 6B show a ray trace of another example apparatus that uses an array of modulators to form an image on a wafer.

### DETAILED DESCRIPTION OF THE CERTAIN PREFERRED EMBODIMENTS

Spatial light modulators may be used in photolithography systems (e.g., instead of masks) to produce patterns on a substrate. Patterns formed on the spatial light modulator can be imaged by imaging optics, referred to as projection optics, onto a photoresist to expose the photoresist. Such spatial light modulators may comprise, for example, microelectromechanical mirror systems (MEMS). However, the size of spatial light modulators can limit the size of resulting patterns. Embodiments of the present invention provide projection optics configured to substantially demagnify light (e.g., by about 100 or by about 300 times or by about 500 times or more) modulated by spatial light modulators, such that fine patterns may be produced.

In some embodiments, systems or methods are provided to fabricate a wafer having an integrated circuit (IC) formed thereon. Example ICs include general purpose microprocessors made from thousands or millions of transistors, a flash memory array or any other dedicated circuitry. However, one skilled in the art will appreciate that the methods and devices described herein can also be applied to the fabrication of any article manufactured using lithography, such as micromachines, disk drive heads, gene chips, micro electro-mechanical systems (MEMS) and so forth.

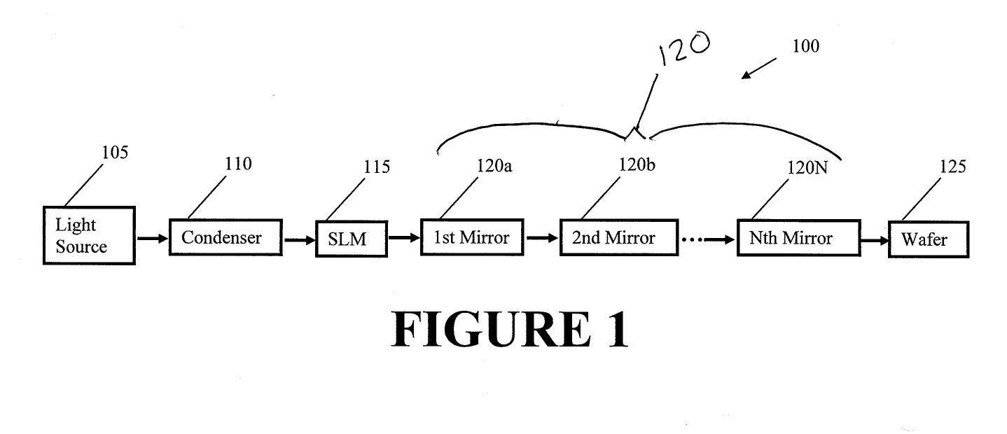

FIG. 1 shows a photolithography system 100. The system 100 comprises a light source 105. The light source 105 may be configured to generate light such as, for example, extreme ultraviolet light or light having shorter wavelengths. For example, the light source 105 can comprise a synchrotron radiative source from an electron ring controlled by a magnetic field, a laser-induced plasma generated by directing a high-repetition rate pump laser onto a continuously sequencing target or a discharge produced plasma or a discharge produced plasma. Other light sources 105, including those yet to be devised, may be used.

The photolithography system 100 includes a condenser 110, which may be configured to uniformly distribute light from the light source 105 across an area. The condenser 110 can be, for example, a critical or Kohler illumination optical system.

The photolithography system 100 may include a spatial light modulator (SLM) 115 that modulates light from the condenser. The SLM 115 may include a programmable array of micromirrors whose reflectance properties can be varied by modulating the mirrors' tilt or translational positions. The mirrors may include interference coatings to provide increased reflectance. Other spatial light modulators may also be used.

The photolithography system 100 may include projection optics 120 to image a pattern formed by the SLM 115 onto a wafer 125. Due to minimum size limits of the SLM 115, the projection optics l20 may operate at a very high reduction ratio. The SLM 115 may, for example, have pixels on the order of 5 microns. Accordingly, the projection optics 120 provides 500×, 300× or 100× demagnification in certain embodiments. In some embodiments, the projection optics 120 are configured such that the magnification (the ratio of the numerical aperture at the wafer 125 to the numerical aperture at the SLM 115 pixel elements) is greater than about 100, 300 or 500. (Conversely, the demagnification is the ratio of the numerical aperture at the SLM 115 versus the numerical aperture at the wafer 125.) Demagnification also corresponds to the image size reduction of the spatial light modulator pattern on the wafer 125. Numerical apertures of the projection optics 120 may be high (e.g., greater than about 0.1, 0.2, 0.3, 0.35, 0.4, or 0.5) at the short conjugate or wafer side, such that small features may be printed on a target structure. The total track distance of the projection optics 120 may be moderate or small, such as less than about 5, 4, 3, 2, or 1 meter, thereby enabling the projection optics to be integrated into semiconductor fabrication systems. Advantageously, in various embodiments described herein, mirrors used in the projection optics 120 may have reflective surfaces characterized by small, reduced or minimal aspheric deviation (e.g., deviation from spherical curvature), such that the components are easy to produce. The projection optics 120 may include high quality optics, such that wavefront aberrations are low (e.g., less than about 0.020, 0.015, 0.010 or 0.005 waves), and/or such that distortion is low (e.g., less than about 5, 3, 2 or 1 nm). A plurality of mirrors may be used to provide aberration correction and result in such low levels of aberration.

For example, the projection optics 120 may include 8, 9, 10 or more mirrors 120a-N. In some embodiments, less mirrors, for example, 2, 3, 4, 5, 6, or 7, may be used. The number of mirrors may be reduced or minimized in order to, for example, reduce manufacturing (e.g., fabrication and alignment) costs, preserve optical transmission, and/or, reduce the total track. Each of the mirrors 120 may be characterized as a mirror with positive power or negative power or may have substantially no (extremely low) power and be considered effectively zero powered. In some embodiments, most or all mirrors in a photolithography system are spherical. In some embodiments, most or all mirrors in a photolithography system are aspheric. In some embodiments, most or all mirrors in a photolithography system are rotationally symmetric about an optical axis, wherein the optical axis can correspond to, for example, the axis around which all of the mirrors show rotational symmetry. An annular ring field may be obtained, a portion of which may be used in a microlithographic system.

A first mirror 120a in the optical path of the projection optics 120 may be a mirror with positive power. A second mirror 120b in the optical path of the projection optics 120 may be a mirror with negative power. A third mirror 120c in the optical path of the projection optics 120 may be a mirror with positive power. A fourth mirror 120d in the optical path of the projection optics may be a mirror with negative power. A last mirror 120N in the optical path of the projection optics 120 may be a positively powered mirror. A second to last mirror 120(N-1) in the optical path of the projection optics 120 may be a negatively powered mirror. Accordingly, in various embodiments, the power of one or more mirrors 120 in the optical path of the projection optics 120 may differ from the power of the adjacent mirrors in the optical path. For example, a positively powered mirror may be positioned adjacent in the optical path to negatively powered and/or unpowered mirrored. Such positive and negative mirror combinations, for example, at the beginning and end of the system (closest to the SLM 115 or to the wafer 125) shortens the total track much like such a combination enables a focal length that is longer than the optical system, such as in a telephoto lens.

In some embodiments, the power of the closest and/or second closest mirror 120N and 120(N-1) to the wafer 125 substantially contribute to the magnification and/or track length of the projection optics. A positively powered mirror 120N closest to the wafer can provide a large numerical aperture and thus demagnification at the wafer. A negatively powered mirror 120(N-1) adjacent thereto in the optical path can provide a short track length for the projection optics. Similarly, a positively powered mirror as the mirror 120a closest to the SLM 115 and a negatively powered mirror 120b adjacent thereto in the optical path can reduce the total track.

The projection optics 120 may be configured to form an intermediate image between the second and third mirrors from the wafer 120(N-2) and 120(N-1) or between the third and fourth mirrors 120(N-2) and 120(N-3) from the wafer. The intermediate image can then be reimaged onto a final image plane (e.g., at or near the wafer). One or both of the two mirrors 120(N-1) and 120N closest in the optical path to the SLM 115 may be substantially conic.

In some embodiments, the third and fourth mirrors in an optical path can form a mirror pair (e.g., a field mirror pair) that receives a plurality of rays that are diverging from the optical axis. The third and fourth mirrors may reflect these diverging rays such that they converge towards the optical axis.

Mirrors of the projection optics may be arranged to constrain one or more angle of incidences. For example, the mirrors may be positioned such that the angle of incidence of EUV light incident on each of the mirrors is less than about 50°, 45°, 40°, 38°, 36°, 34°, 32°, 30°, 25°, or 20° with respect to the normal to the surface. The low angles of incident may improve the reflection of multi-layer coating stacks, comprising e.g., MoSi. The stacks designed for normal may experience reduced reflectivity with deviations from normal incidence.

Light may also be substantially normally incident on the wafer. When the cone of light is normally incident on the wafer, or telecentric, the image position does not shift as the wafer moves through focus as a result, for example, of errors in the stage or because the wafer is not flat. Telecentric optics are helpful in meeting the distortion requirements for photolithography systems over a real range of operating conditions.

Light may be incident on the modulators at non-normal angles. Non-normal incident angles may prevent the mirrors from occluding the light path to the modulators. Light may be incident on modulators at, for example, angles greater than about 0°, 0.1°, 1°, 2°, 3°, 5°, 6°, 7°, 8°, 9°, 10°, or 15°, and/or at angles less than about 1°, 2°, 3°, 5°, 6°, 7°, 8°, 9°, 10°, 15°, or 20° with respect to the normal to the surface. The angles of incidence on the modulators may be small in order to improve the reflectance of the modulators. In some embodiments, modulators can be designed (e.g., by using coatings) to reflect off-axis light. In these embodiments, a small range of angles incident on the modulators may improve the reflectance of the modulators. For example, modulators incorporating mirrors comprising dielectric stacks may be configured to reflect light of specific wavelengths and specific off-axis angles for which the light is expected be incident. The angles of incidence on the modulators may be constrained to a range, for example, of about 0.05°, 0.1°, 0.2°, 0.3°, 0.4°, 0.5°, 0.6°, 0.8°, or 1°.

### EXAMPLES

### Example 1

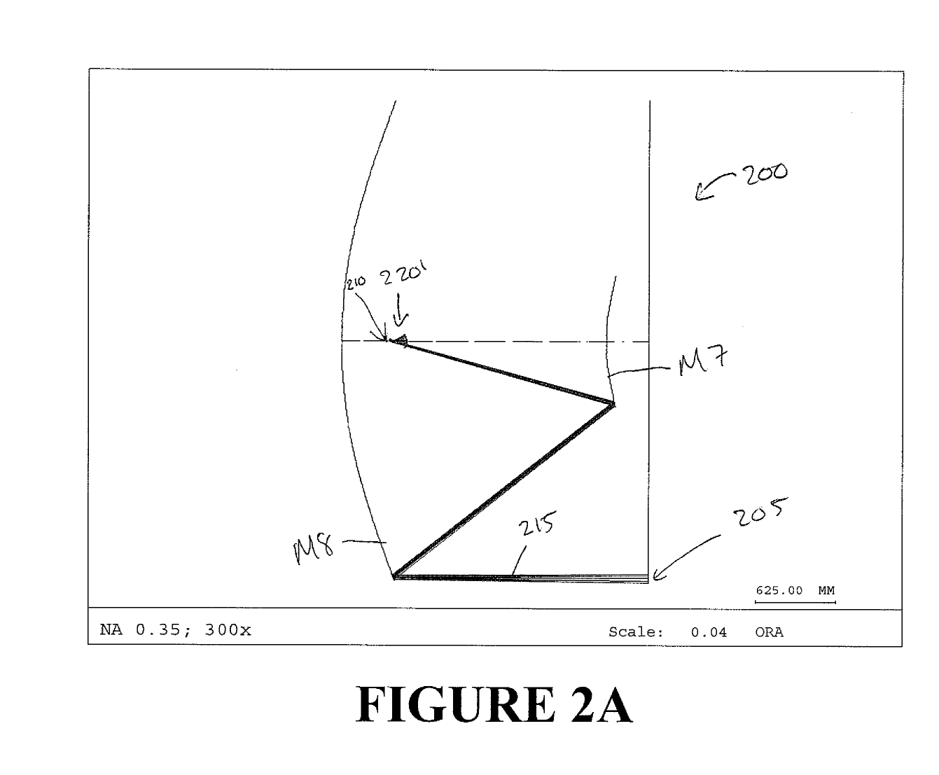

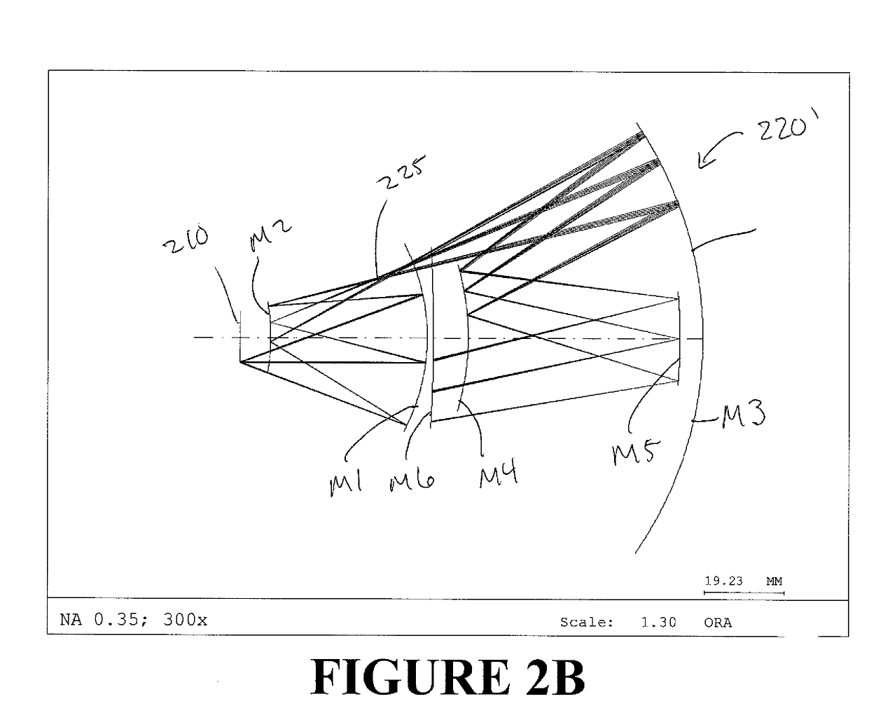

FIG. 2A shows a ray trace of an example optical system that achieves high levels of demagnification. A corresponding optical prescription in Code V® by Optical Research Associates Pasadena, Calif., is shown in Appendix I. FIG. 2A shows a first photolithography apparatus 200 that uses an array of modulators 205 to form an image on a wafer 210. The apparatus 200 includes projection optics, here comprising eight mirrors M1-M8, which image the spatial light modulators 205 onto the wafer 210. The modulators 205 and the wafer 210 are thus conjugates, e.g., conjugate planes. The distance from the projection optics to the wafer is smaller and thus is referred to as the short conjugate. The distance from the projection optics to the modulators 205 is longer and thus is referred to as the long conjugate. Likewise, the projection optics demagnifies from the modulators 205 to the wafer 210. The projection optics is said to be reflective because reflective elements or mirrors are used. FIG. 2A shows rays traced from the wafer 210 to the modulators 205 and accordingly, the wafer is referred to as the object OBJ and the modulators are referred to as the image (IMG) in the prescription and the following discussion of this example. Object and image planes can be, for example, accessible for parallel scanning. In some embodiments, all mirrors in a photolithography system described herein are, for example, between the object and image planes. Similarly, the mirror closest to the wafer is referred to as the first mirror M1 and the mirror closest to the modulator is referred to as the eighth mirror M8. In operation, light 215 modulated by the modulators 205 is reflected by a positively powered eighth mirror M8, by a negatively powered seventh mirror M7, and then by mirrors within the projection optics subassembly 220′ to form an image at the wafer 210.

The projection optics subassembly 220′ is shown in FIG. 2B. Light reflected from the seventh mirror M7 is first reflected from the negatively-powered sixth mirror M6, next by the positive-powered fifth mirror M5, and then by the negatively powered fourth mirror M4. The light then reflects from the positively powered third mirror M3 and forms an intermediate image 225 in the optical path between the third and second mirrors M3 and M2. The light reflects off of the negatively powered second mirror M2, and then off the positively powered first mirror M1 to form an image at the wafer 210.

The magnification of the system corresponding to, for example, the ratio of the numerical aperture at the wafer to the numerical aperture at the array—is 300. The demagnification, reduction in image size compared to object size, is therefore also 300×, i.e., 1/300 of the size. The field of the projection optics at the wafer is an annulus with an inner semi-diameter (half of the diameter) of 6 mm and an outer semi-diameter of 6.2 mm. The projection optics have a maximum wavefront error of 9.8 mλ and a distortion of 1.5 nm for this system, which also has a numerical aperture of 0.35. The angle of incidence of the light on any of the projection optics mirrors in this example is less than 30.5°. The system is arranged such that the angle of incidence of light on the modulators is between 0.1° and 1°. The stop is at or near M5 (for example nearer to M5 than to any other mirror).

### Example 2

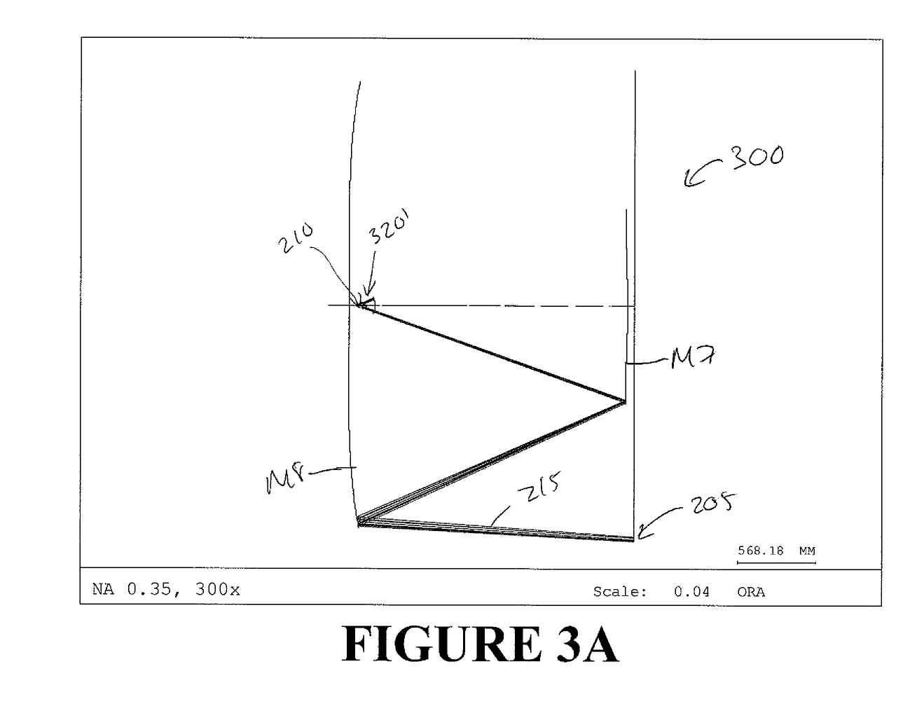

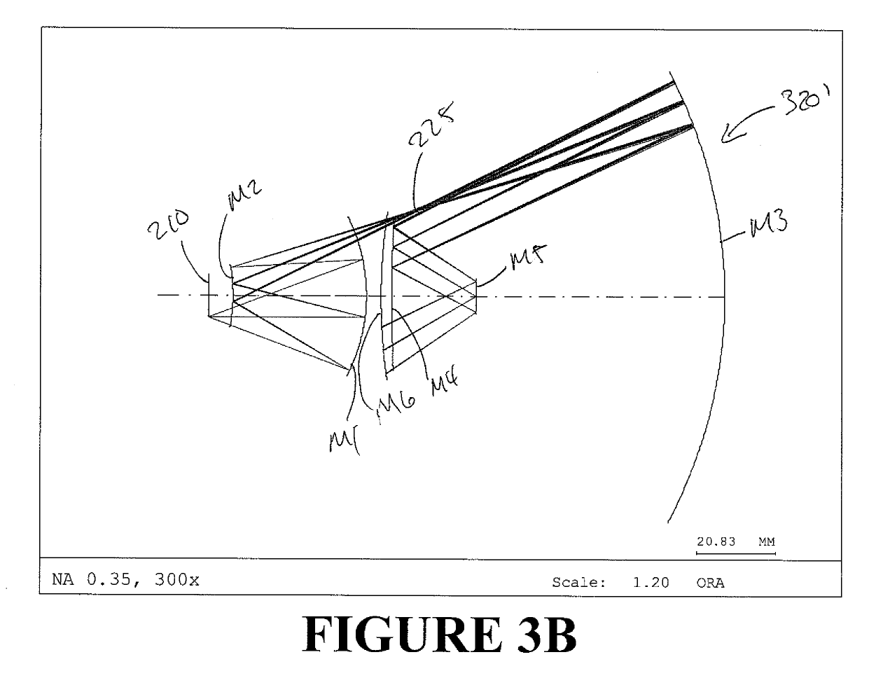

FIG. 3A shows a ray trace of an example optical system that achieves high levels of demagnification. A corresponding optical prescription in Code V® by Optical Research Associates Pasadena, Calif., is shown in Appendix II. FIG. 3A shows a second photolithography apparatus 300 that uses an array of modulators 205 to form an image on a wafer 210. The apparatus 300 includes projection optics, here comprising eight mirrors M1-M8, which image the spatial light modulators 205 onto the wafer 210. Conjugates, objects and images are as described in Example 1. The mirror closest to the wafer is referred to as the first mirror M1 and the mirror closest to the modulator is referred to as the eighth mirror M8. In operation, light 215 modulated by the modulators 205 is reflected by a positively powered eighth mirror M8, by a positively powered seventh mirror M7, and then by mirrors within the projection optics subassembly 320′ to form an image at the wafer 210.

The projection optics apparatus 320′ is shown in FIG. 3B. Light reflected from the seventh mirror M7 is first reflected from the positively powered sixth mirror M6, next by the negatively-powered fifth mirror M5, and then by the positively-powered fourth mirror M4. The light then reflects from the positively powered third mirror M3 and forms an intermediate image 225 between the third and second mirrors M3 and M2. The light reflects off of the negatively powered second mirror M2, and then off the positively powered first mirror M1 to focus on an image at the wafer 210.

The magnification of the system—corresponding to, for example, the ratio of the numerical aperture at the wafer to the numerical aperture at the array—is 300. The demagnification, reduction in image size compared to object size, is therefore also 300×, i.e., 1/300 of the size. The field of the projection optics at the wafer is an annulus with an inner semi-diameter of 5.5 mm and an outer semi-diameter of 5.6 mm. The projection optics have a maximum wavefront error of 2.8 mλ and a distortion of 0.5 nm for this system, which also has a numerical aperture of 0.35. The angle of incidence on any of the projection optics mirrors is less than 30.5°. The system is arranged such that the angle of incidence of light on the modulators is between 2.2° and 3.3°. The stop is at or near M5 (for example nearer to M5 than to any other mirror).

### Example 3

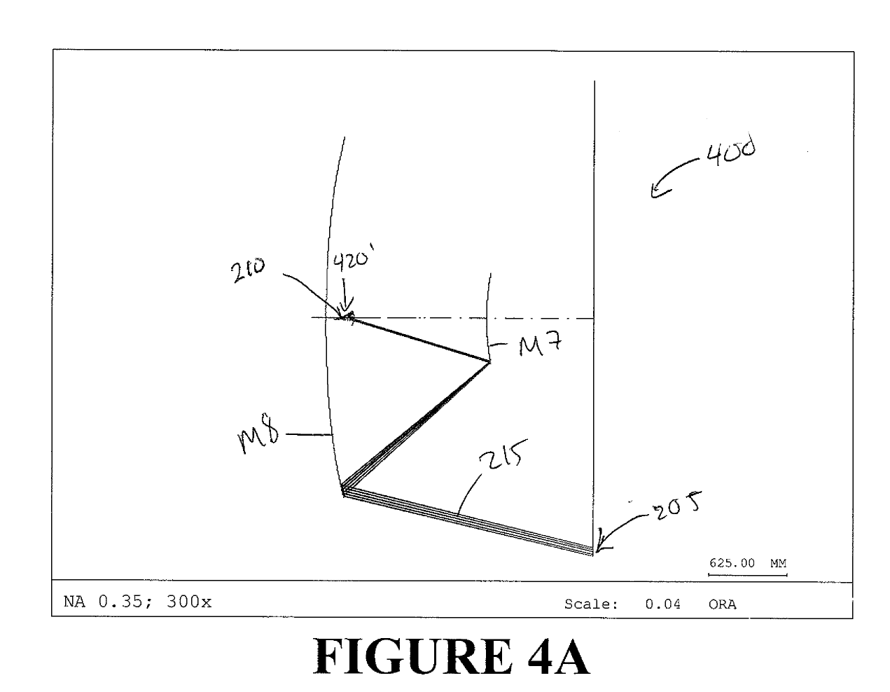

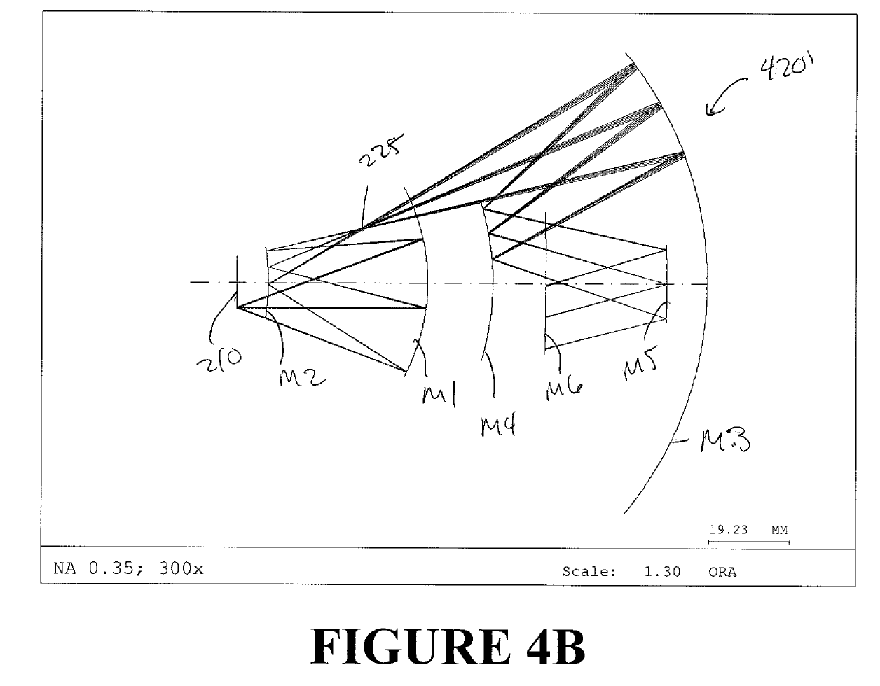

FIG. 4A shows a ray trace of an example optical system that achieves high levels of demagnification. A corresponding optical prescription in Code V® by Optical Research Associates Pasadena, Calif., is shown in Appendix III. FIG. 4A shows a third photolithography apparatus 400 that uses an array of modulators 205 to form an image on a wafer 210. The apparatus 400 includes projection optics, here comprising eight mirrors M1-M8, which image the spatial light modulators 205 onto the wafer 210. Conjugates, objects and images are as described in Example 1. The mirror closest to the wafer is referred to as the first mirror M1 and the mirror closest to the modulator is referred to as the eighth mirror M8. In operation, light 215 modulated by the modulators 205 is reflected by a positively powered eighth mirror M8, by a negatively powered seventh mirror M7, and then by mirrors within the projection optics subassembly 420′ to form an image at the wafer 210.

The projection optics apparatus 420′ is shown in FIG. 4B. Light reflected from the seventh mirror M7 is first reflected from the low-powered sixth mirror M6, next by the positively powered fifth mirror M5, and then by the negatively powered fourth mirror M4. The light then reflects from the positively powered third mirror M3 and forms an intermediate image 225 between the third and second mirrors M3 and M2. The light reflects off of the negatively powered second mirror M2, and then off the positively powered first mirror M1 to focus on an image at the wafer 210.

The magnification of the system—corresponding to, for example, the ratio of the numerical aperture at the wafer to the numerical aperture at the array—is 300. The demagnification, reduction in image size compared to object size, is therefore also 300×, i.e., 1/300 of the size. The field of the projection optics at the wafer is an annulus with an inner semi-diameter of 6 mm and an outer semi-diameter of 6.2 mm. The projection optics have a maximum wavefront error of 3.1 mλ and a distortion of 0.8 nm for this system, which also has a numerical aperture of 0.35. The angle of incidence on any of the projection optics mirrors is less than 31.8°. The system is arranged such that the angle of incidence of light on the modulators is between 13.3° and 13.8°. The stop is at or near M5 (for example nearer to M5 than to any other mirror).

### Example 4

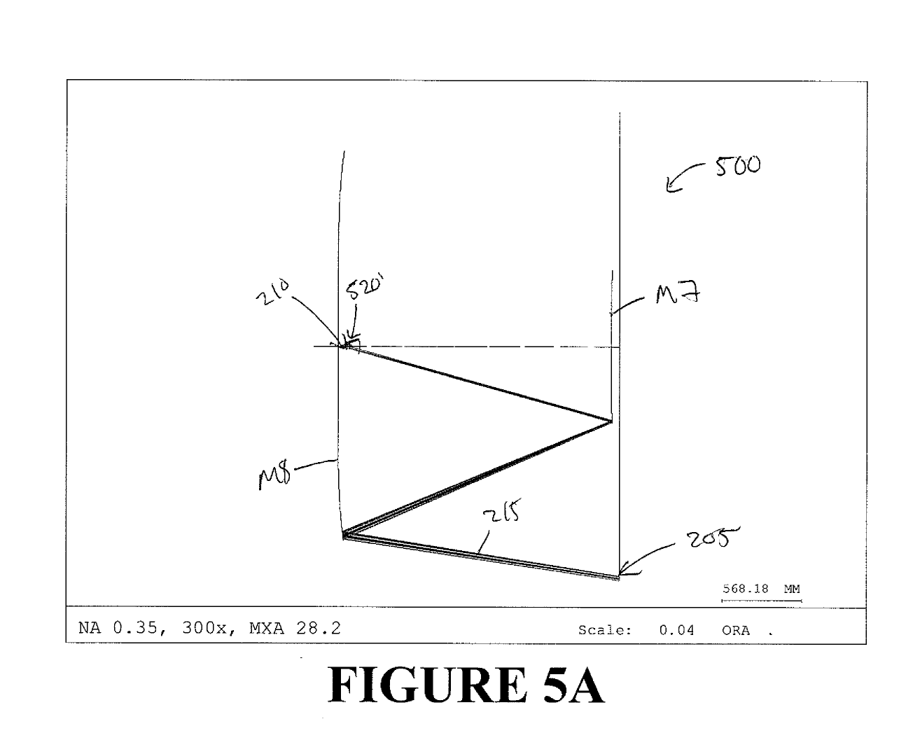

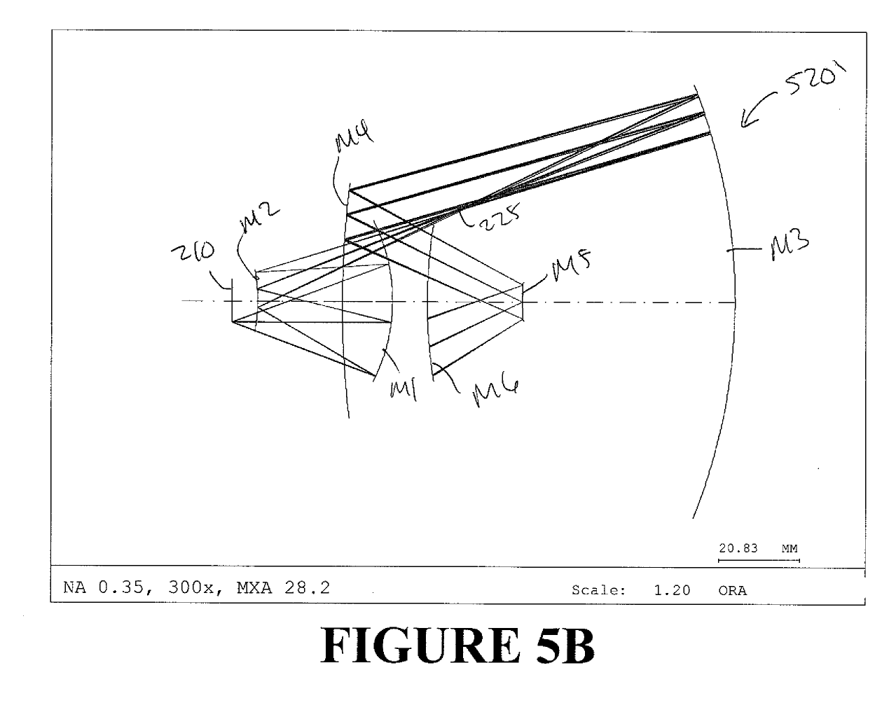

FIG. 5A shows a ray trace of an example optical system that achieves high levels of demagnification. A corresponding optical prescription in Code V® by Optical Research Associates Pasadena, Calif., is shown in Appendix IV. FIG. 5A shows a fourth photolithography apparatus 500 that uses an array of modulators 205 to form an image on a wafer 210. The apparatus 500 includes projection optics, here comprising eight mirrors M1-M8, which image the spatial light modulators 205 onto the wafer 210. Conjugates, objects and images are as described in Example 1. The mirror closest to the wafer is referred to as the first mirror M1 and the mirror closest to the modulator is referred to as the eighth mirror M8. In operation, light 215 modulated by the modulators 205 is reflected by a positively powered eighth mirror M8, by a negatively powered seventh mirror M7, and then by mirrors within the projection optics subassembly 520′ to form an image at the wafer 210.

The projection optics apparatus 520′ is shown in FIG. 5B. Light reflected from the seventh mirror M7 is first reflected from the positively powered sixth mirror M6, next by the negatively powered fifth mirror M5, and then by the positively powered fourth mirror M4. The light then reflects from the positively powered third mirror M3 and forms an intermediate image 125 between the third and second mirrors M3 and M2. The light reflects off of the negatively powered second mirror M2, and then off the positively powered first mirror Ml to focus on an image at the wafer 210.

The magnification of the system corresponding to, for example, the ratio of the numerical aperture at the wafer to the numerical aperture at the array—is 300. The demagnification, reduction in image size compared to object size, is therefore also 300×, i.e., 1/300 of the size. The field of the projection optics at the wafer is an annulus with an inner semi-diameter of 5.5 mm and an outer semi-diameter of 5.6 mm. The projection optics have a maximum wavefront error of 1.9 mλ and a distortion of 0.4 nm for this system, which also has a numerical aperture of 0.35. The angle of incidence on any of the projection optics mirrors is less than 28.7°. The system is arranged such that the angle of incidence of light on the modulators is between 7.4° and 8.4°. The stop is at or near M5 (for example nearer to M5 than to any other mirror).

### Example 5

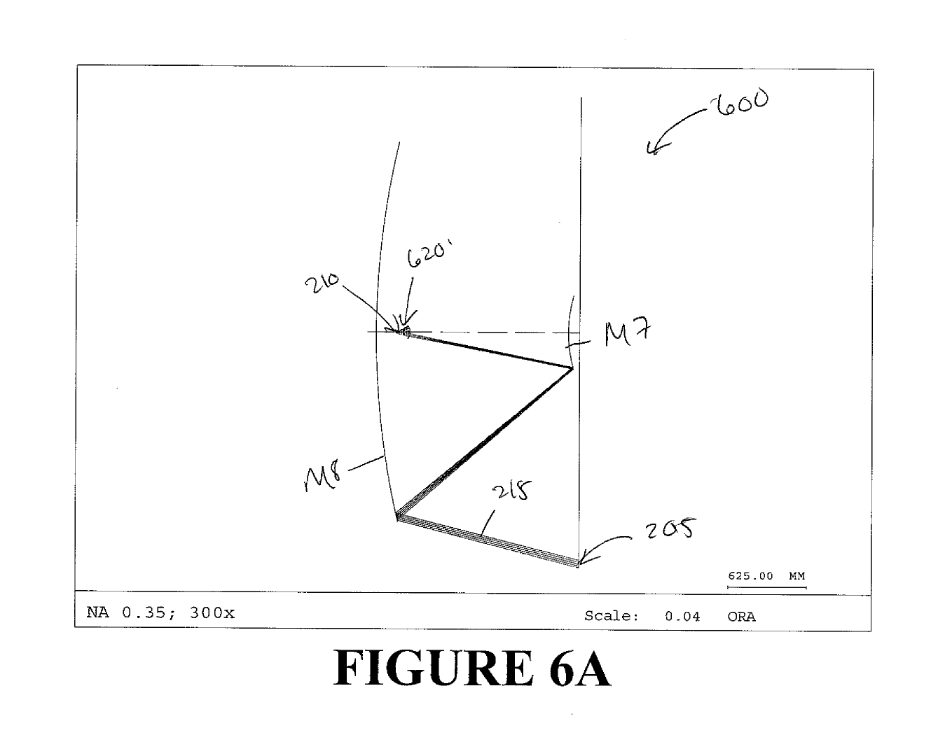

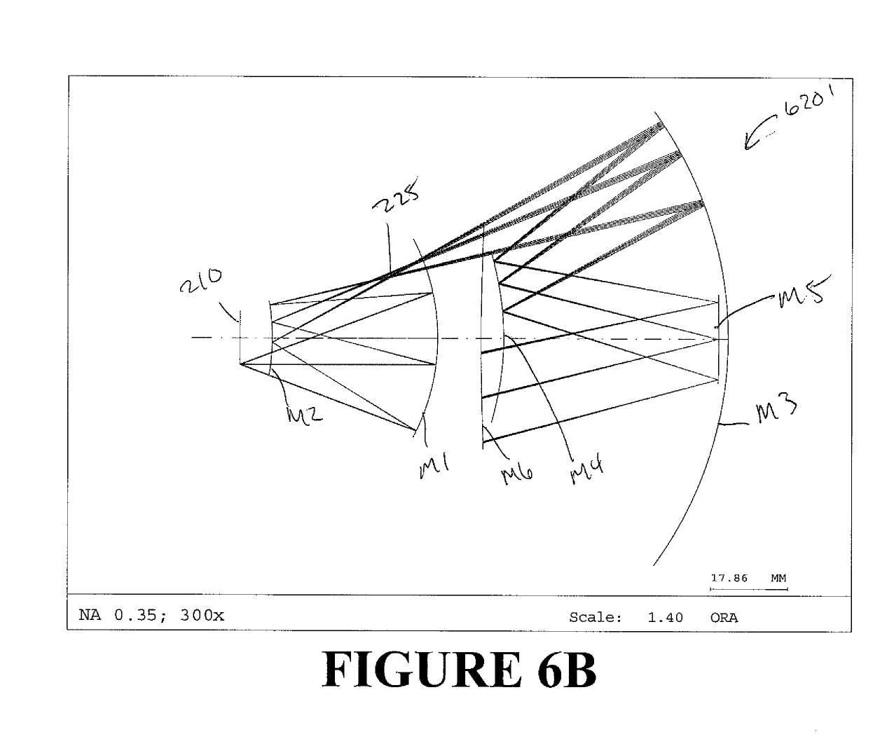

FIG. 6A shows a ray trace of an example optical system that achieves high levels of demagnification. A corresponding optical prescription in Code V® by Optical Research Associates Pasadena, Calif., is shown in Appendix V. FIG. 6A shows a fifth photolithography apparatus 600 that uses an array of modulators 205 to form an image on a wafer 210. The apparatus 600 includes projection optics, here comprising eight mirrors M1-M8, which image the spatial light modulators 205 onto the wafer 210. Conjugates, objects and images are as described in Example 1. The mirror closest to the wafer is referred to as the first mirror M1 and the mirror closest to the modulator is referred to as the eighth mirror M8. In operation, light 215 modulated by the modulators 205 is reflected by a positively powered eighth mirror M8, by a negatively powered seventh mirror M7, and then by mirrors within the projection optics subassembly 620′ to form an image at the wafer 210.

The projection optics apparatus 620′ is shown in FIG. 6B. Light reflected from the seventh mirror M7 is first reflected from the positively powered sixth mirror M6, next by the positively powered fifth mirror M5, and then by the negatively powered fourth mirror M4. The light then reflects from the positively powered third mirror M3 and forms an intermediate image 225 between the third and second mirrors M3 and M2. The light reflects off of the negatively powered second mirror M2, and then off the positively powered first mirror M1 to focus on an image at the wafer 210. The seventh and eighth mirrors M7 and M8 are substantially conic sections. The first through sixth mirrors M1-M6 have deviations from best fit spheres of less than 41 μm.

The magnification of the system—corresponding to, for example, the ratio of the numerical aperture at the wafer to the numerical aperture at the array—is 300. The demagnification, reduction in image size compared to object size, is therefore also 300×, i.e., 1/300 of the size. The field of the projection optics at the wafer is an annulus with an inner semi-diameter of 6 mm and an outer semi-diameter of 6.2 mm. The projection optics have a maximum wavefront error of 10 mλ and a distortion of 0.3 nm for this system, which also has a numerical aperture of 0.35. The angle of incidence on any of the projection optics mirrors is less than 30.6°. The system is arranged such that the angle of incidence of light on the modulators is between 14.0° and 14.4°. The stop is at or near M5 (for example nearer to M5 than to any other mirror).

A wide variety of alternative configurations are possible. For example, components (e.g., mirrors) may be added, removed, or rearranged. Similarly, processing and method steps may be added, removed, or reordered.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while several variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. A maskless extreme ultraviolet photolithography system comprising a reflective relay comprising:
at least a first mirror, a second mirror, a third mirror, a fourth mirror, a fifth mirror, a sixth mirror, a seventh mirror and an eighth mirror arranged in an optical path from an object plane to an image plane for imagining a spatial light modulator in said object plane into a wafer in said image plane, said mirrors having a shape and location with respect to each other within the optical path such that said reflective relay yields a reduction ratio of at least about 100 times.

2. The system of claim 1, wherein the shape and location of said mirrors are such that said reflective relay has a numerical aperture at a short conjugate plane of at least about 0.35.

3. The system of 1, wherein the shape and location of said minors are such that said reflective relay has a reduction ratio of at least about 300 times.

4. The system of claim 1, wherein the shape and location of said mirrors are such that the total track distance from said object plane to said image plane is less than or equal to about 3 meters.

5. The system of claim 1, wherein said mirrors are arranged in order in the optical path such that light is reflected from said first mirror to said second mirror, from said second mirror to said third mirror, from third mirror to said fourth mirror, from said fourth mirror to said fifth mirror, from said fifth mirror to said sixth mirror, from said sixth mirror to said seventh mirror, and from said seventh mirror to said eighth mirror.

6. The system of claim 5, wherein said first mirror is the closest mirror in said optical path to said object plane having optical power and said first mirror has positive power.

7. The system of claim 5, wherein said second mirror is the second closest mirror in said optical path to said object plane having optical power and said second mirror has negative power.

8. The system of claim 1, wherein the mirror in said optical path closest to said image plane that has positive optical power.

9. The system of claim 1, wherein the reflective relay is telecentric at the wafer.

10. The system of claim 1, wherein the two mirrors in said optical path having optical power that are closest to said image plane have positive and negative optical power, with the positive optical power mirror being closer in said optical path to said image plane.

11. The system of claim 1, wherein the three mirrors in said optical path having optical power that are closest to said image plane have positive, negative, and positive optical power, with the negative optical power mirror being in between said positive optical power mirrors in said optical path.

12. The system of claim 5, wherein said eighth mirror has positive power.

13. The system of claim 12, wherein said seventh mirror has negative power.

14. The system of claim 12, wherein said sixth mirror has positive power.

15. The system of claim 5, wherein the mirrors are configured such that an intermediate image is formed between the mirror second closest to the image plane and the mirror third closest to the image plane.

16. The system of claim 5, wherein the mirrors are configured such that an intermediate image is formed between the mirror third closest to the image plane and the mirror fourth closest to the image plane.

17. The system of claim 5, wherein said first and second mirrors comprise reflective surfaces that are substantially conic sections.

18. The system of claim 5, wherein said reflective relay does not have consecutive mirrors in said optical path that are positively powered mirrors unless the maximum distance from the optical axis of one of said mirrors divided by the radius of curvature is less than 0.05.

19. The system of claim 5, wherein said reflective relay does not have consecutive mirrors in said optical path that are negative powered mirrors unless the maximum distance from the optical axis of one of said mirrors divided by the radius of curvature is less than 0.05.

20. The system of claim 5, wherein said third and fourth mirrors form a field mirror pair, said field mirror pair receives a plurality of rays that are diverging from the optical axis, and said field mirror pair reflecting said diverging rays such that they converge towards the optical axis.

21. The system of claim 1, wherein said mirrors have a shape and location such that said reflective relay has a maximum RMS wavefront error of less than about 0.010 λ over an annular ring greater than 10 mm wide at a long conjugate.

22. The system of claim 1, wherein said mirrors have a shape and location such that said reflective relay has a maximum distortion of less than about 1 nanometer over an annular ring greater than 10 mm wide at a long conjugate.

23. The system of claim 1, further comprising an extreme ultraviolet light source.

24. The system of claim 1, further comprising a spatial light modulator array at said object plane.

25. The system of claim 1, further comprising a wafer stage configured to support a semiconductor wafer.

26. A method of patterning a semiconductor wafer, comprising:
modulating extreme ultraviolet light to form an object pattern;
reflecting said modulated extreme ultraviolet light from a first mirror, a second mirror, a third mirror, a fourth mirror, a fifth mirror, a sixth mirror, a seventh mirror and an eighth mirror to form an image pattern; and
demagnifying said image pattern by at least 100 times relative to said object pattern, and
exposing said semiconductor wafer with said image pattern.

27. An EUV optical projection system, comprising:
an extreme ultraviolet light source;
an array of spatial light modulators configured to modulate light generated from the light source to form an object pattern; and
at least eight mirrors configured to image said object pattern to form an image pattern on a wafer and to reduce said image pattern by at least about 100 times relative to said object pattern.

28. The system of claim 27, wherein said eight mirrors have shapes and locations to provide a numerical aperture at said image is at least about 0.35.

29. An optical imaging system comprising a reflective relay comprising:
at least a first mirror, a second mirror, a third mirror, a fourth mirror, a fifth mirror, a sixth mirror, a seventh mirror and an eighth mirror arranged in an optical path from an object plane to an image plane for imaging a spatial light modulator in said object plane onto a wafer in said image plane, said mirrors having a shape and location with respect to each other within the optical path such that said reflective relay yields a reduction ratio of at least about 100 times.
